(19) United States
(12) Patent Application Publication
(10) Pub. No.: US 2010/0043474 A1
(43) Pub. Date: Feb. 25, 2010

(54) SELF-CONTAINED EVAPORATIVE COOLING SYSTEM

(76) Inventor: Christopher J. Strussion, Bellaire, OH (US)

Correspondence Address: ESCHWEILER & ASSOCIATES, LLC;NATIONAL CITY BANK BUILDING, 629 EUCLID AVE., SUITE 1000, CLEVELAND, OH, 44114, US

(21) Appl. No.: 12/546,414

(22) Filed: Aug. 24, 2009

Related U.S. Application Data
(60) Provisional application No. 61/090,980, filed on Aug. 22, 2008.

(51) Int. Cl. F28D 5/00; B23P 19/04

(52) U.S. Cl. 62/259.4; 62/314; 29/801

(57) ABSTRACT

A portable evaporative cooling system having a misting apparatus has a fan generating an air path and a spraying apparatus dispersing water in the air path. A water container has an elongate body wherein the water container has a cross-sectional profile that at least partially approximates a cross-sectional profile of the misting apparatus. The misting apparatus selectively slidingly engages at least part of the cross-sectional profile of the water container, therein selectively securing the fan inside the water container. A lid is in selective cooperative engagement with the open end of the water container and has an access port therethrough. In a first configuration, the lid encloses the misting apparatus within an interior region of the water container, and in a second configuration, the misting apparatus is operatively coupled to an external portion of the lid, wherein the misting apparatus draws water through the access port.

### REFERENCE TO RELATED APPLICATION

This application claims priority to and the benefit of U.S. Provisional Application Ser. No. 61/090,980 which was filed Aug. 22, 2008, entitled MISTING FAN DEVICE, the entirety of which is hereby incorporated by reference as if fully set forth herein.

### FIELD OF THE INVENTION

The present invention relates to an evaporative cooling system and, more particularly, to a water cooler configured to alternatively mount an evaporative cooling apparatus thereto and protect the evaporative cooling apparatus therein.

### BACKGROUND OF THE INVENTION

Evaporative coolers are used in a variety of settings including factories, warehouses, workshops and agricultural structures, as well as automobiles, homes, offices, trailers and at the sidelines of sporting events. Evaporative cooling improves workplace productivity by keeping workers cool in the workplace which, in turn, reduces heat-related illness and employee turn-over, particularly in the summer months and/or in hotter climates. It also improves performance of sports players by keeping players cool or preventing heat exhaustion in sports that demand extended periods of physical exertion.

Evaporative coolers typically require fewer parts and are relatively more simple to manufacture and maintain than conventional air conditioning and mechanical refrigeration systems.

### SUMMARY OF THE INVENTION

The present invention provides a self-contained evaporative cooling system and apparatus comprising a water cooler that is configured to mount an evaporative cooling apparatus thereto for providing evaporative cooling, wherein the cooler is further configured to stow and protect the evaporative cooling apparatus therein, when not in use for evaporative cooling. Consequently, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

The present invention is directed generally toward a system and method for providing evaporative cooling. In accordance with the disclosure, the system comprises a misting apparatus comprising a fan and a spraying apparatus, wherein the fan is configured to generate a path of air. The spraying apparatus is further configured to disperse water in the path of air generated by the fan for subsequent evaporation of the dispersed water.

According to one aspect, a substantially hollow water container operable to store the water is provided, wherein the water container has an elongate body having an open end and a closed end. When viewed at least from the open end, the water container has a cross-sectional profile that at least partially approximates a cross-sectional profile of the misting apparatus. Thus, the misting apparatus is configured to selectively slidingly engage at least part of the cross-sectional profile of the water container, therein selectively securing the fan inside a volume of the water container.

A lid is in further selective cooperative engagement with the open end of the water container, wherein the lid has an access port therethrough. In a first configuration, the misting apparatus is operatively coupled to an external portion of the lid, wherein the misting apparatus is configured to draw water from the water container through the access port. In a second configuration, the lid encloses the misting apparatus within an interior region of the water container.

In accordance with another aspect, the misting apparatus further comprises a base operably coupled to the fan. An external portion of the lid further comprises a recess defined therein, wherein the recess is sized and shaped to provide a compression fit around at least a portion of the base, therein selectively securing the base to the lid in the first configuration. According to one example, one or more of the base and recess are generally cylindrical or frustoconical in shape. One or more engagement members associated with one or more of the base and the recess can be further provided, wherein the one or more engagement members selectively affix the base to the lid in the first configuration. According to another example, the base further comprises a shoulder, wherein a lower portion of the base is configured to selectively engage the recess of the lid. The shoulder is further configured to stabilize the base about a top portion of the lid in the first configuration.

In accordance with yet another exemplary aspect, the cross-sectional profile of the water container comprises a substantially cylindrically shaped portion interrupted by one or more transverse extensions extending radially outward therefrom. The one or more transverse extensions are thus configured to slidingly engage at least a portion of the fan of the misting apparatus in the second configuration. In one particular example, the cross-sectional profile of the water container comprises two transverse extensions diametrically-opposed from one another, wherein the two transverse extensions are configured to slidingly engage diametrically opposed portions of the fan in the second configuration.

According to still another example, one or more of the water container and lid comprise one or more handles defined therein, wherein the one or more handles provide a location for carrying the portable evaporative cooling system. The one or more handles, in another example, selectively provide a fluid communication between the interior region of the water container and an external environment.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a perspective view of an exemplary evaporative cooling system according to one aspect of the invention.

FIG. 2 is a side view of an exemplary water container in accordance with another aspect of the present invention.

FIG. 3 is a another perspective view of an exemplary water container according to still another aspect of the invention

FIG. 4 is a front view of an exemplary evaporative cooling system in a first configuration in accordance with yet another aspect of the invention.

FIGS. 5A-5B are respective front and side views of an exemplary misting apparatus.

FIG. 6 is a cross-sectional view of an exemplary evaporative cooling system.

FIG. 7 is a front view of an exemplary evaporative cooling system in a second configuration in accordance with yet another aspect of the invention.

FIG. 8 is a block diagram of an exemplary method for utilizing and stowing an evaporative cooling system according to another exemplary aspect of the invention.

### DETAILED DESCRIPTION OF THE INVENTION

The present invention is directed generally towards a system, apparatus, and method for evaporative cooling. More particularly, the system provides a self-stowing portable evaporative cooling system and apparatus. Accordingly, the present invention will now be described with reference to the drawings, wherein like reference numerals are used to refer to like elements throughout. It should be understood that the description of these aspects are merely illustrative and that they should not be taken in a limiting sense. In the following description, for purposes of explanation, numerous specific details are set forth in order to provide a thorough understanding of the present invention. It will be evident to one skilled in the art, however, that the present invention may be practiced without these specific details.

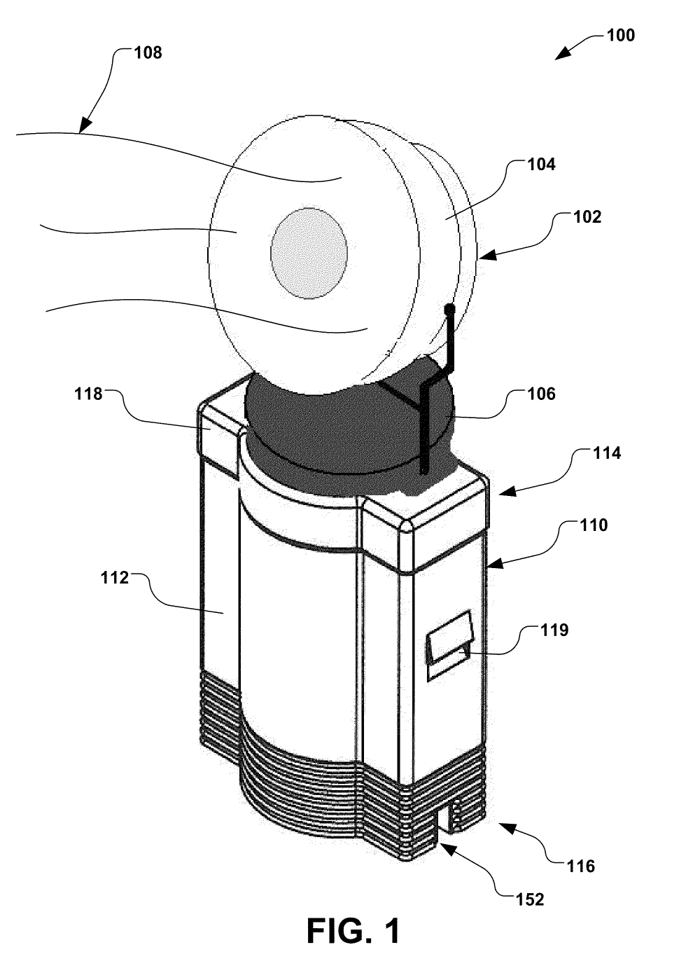

Referring now to the figures, FIG. 1 illustrates an exemplary portable evaporative cooling system 100 in accordance with the present invention. The evaporative cooling system 100, for example, comprises a misting apparatus 102, wherein the misting apparatus comprises a fan 104 and a spraying apparatus 106. The fan 104, for example, is configured to generate a path of air 108, and wherein the spraying apparatus 106 is configured to disperse water (not shown) in the path of air generated by the fan for evaporation thereof. For example, the misting apparatus 102 and spraying apparatus 106 can comprise similar components to those disclosed in co-owned U.S. Pat. No. 6,367,278, the contents of which are incorporated by reference herein in their entirety. For example, the misting apparatus 102 further comprises a water pump (not shown) in fluid communication with the water container 110 for drawing water therefrom, as well as one or more misting nozzles (not shown) disposed downstream of the fan 104 and in the path of air 108 generated by the fan.

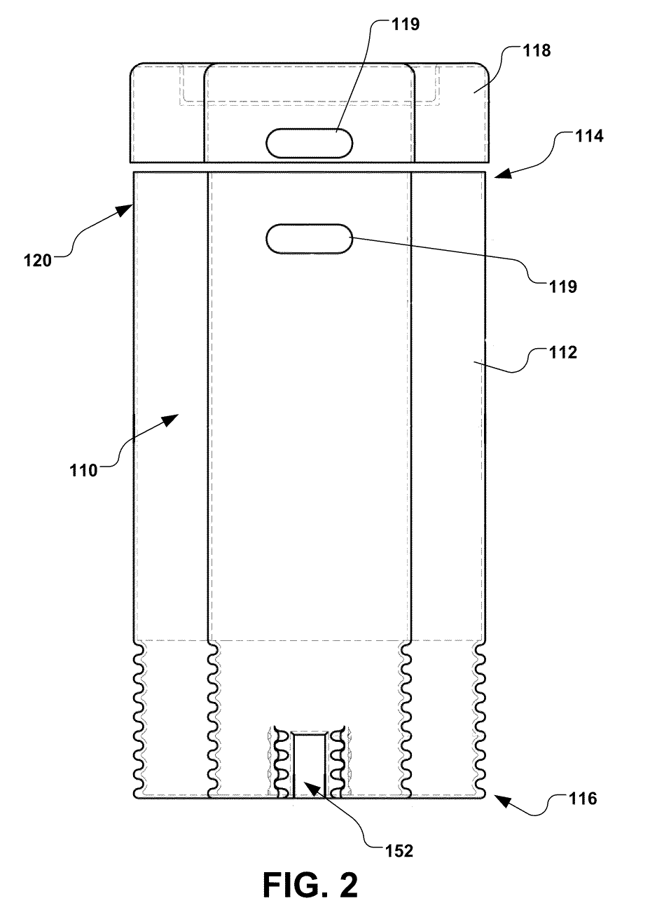

In accordance with one exemplary aspect of the present invention, a substantially hollow water container 110 is provided, wherein the water container is operable to store the water (not shown) used for evaporation. The water container 110, for example, can comprise an insulated vessel, un-insulated vessel, or other vessel, wherein the water container has an elongate body 112 having an open end 114 and a closed end 116, as shown in a side view in FIG. 2. The water container 110 further comprises a lid 118 in selective cooperative engagement with the open end 114 of the water container. The lid 118, in one example, overlaps a portion 120 of the open end 114 of the elongate body 112, therein selectively enclosing the water container 110, as illustrated in FIGS. 1 and 2. Alternatively, the lid 118 can be hinged, press-fit, or otherwise operatively coupled to the open end 114 of the water container 110. Accordingly, the present invention contemplates the lid 118 being operably selectively coupled to the water container 110 in a myriad of ways such that the lid is configured to selectively expose the open end 114 of the elongate body 112; all of which are contemplated as falling within the scope of the present invention. wherein one or more of the water container and lid further comprise insulative material configured to thermally insulate the water in the water container.

One or more of the water container 110 and lid 118, for example, comprise one or more handles 119 associated therewith, wherein the one or more handles provide a location for carrying the portable evaporative cooling system 100. The one or more handles 119, for example, can be further configured to provide a selectively fluid communication between the interior of the water container and an external environment. The selective fluid communication provided by the handles 119, for example, can provide a flow of air into and out of the water container for adequate drying of the water container after emptying. Thus, during storage of the misting apparatus 102, as will be described infra, corrosion and/or degradation of the misting apparatus can be ameliorated.

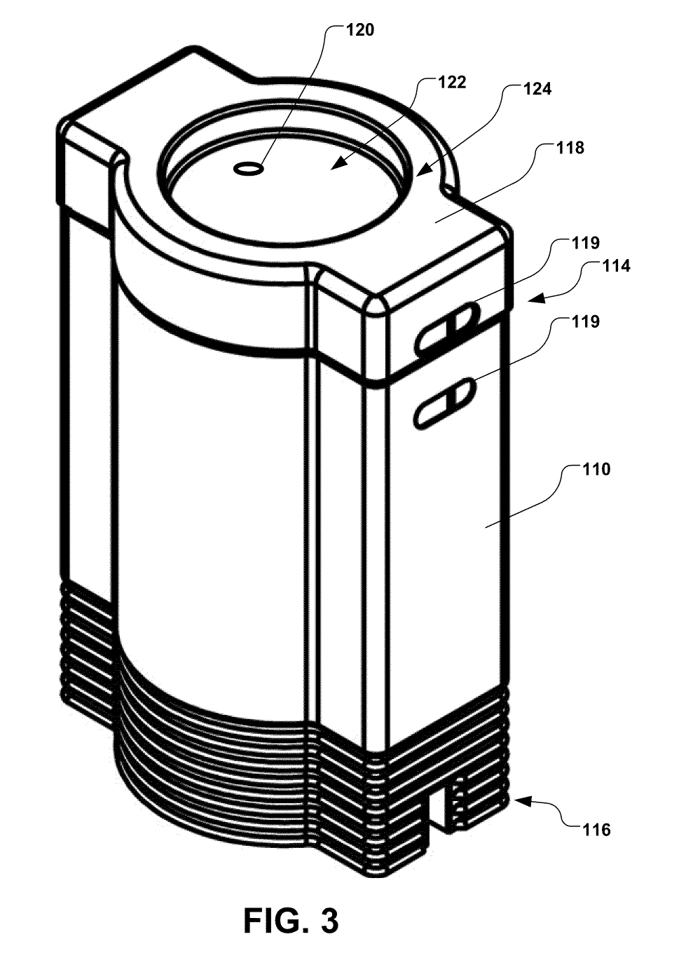

FIG. 3 illustrates the water container 110 and lid 118 in accordance with another exemplary aspect of the invention. The lid 118, for example, comprises an access port 120 therethrough, wherein the misting apparatus 102 of FIG. 1, for example, is configured to draw water from the water container 110 through the access port. For example, one or more suction and/or return tubes (not shown) may be passed through the access port 120 in the lid 118 for fluid communication between the spraying apparatus 106 and the water disposed within the water container 110. A port sealing member (not shown) can be further provided, wherein the port sealing member is configured to selectably engage the access port for selective sealing thereof. FIG. 3 further illustrates a recess 122 defined in an external portion 124 of the lid 118, wherein the recess 122, for example, is configured to support the misting apparatus 102, as will be discussed in further detail infra.

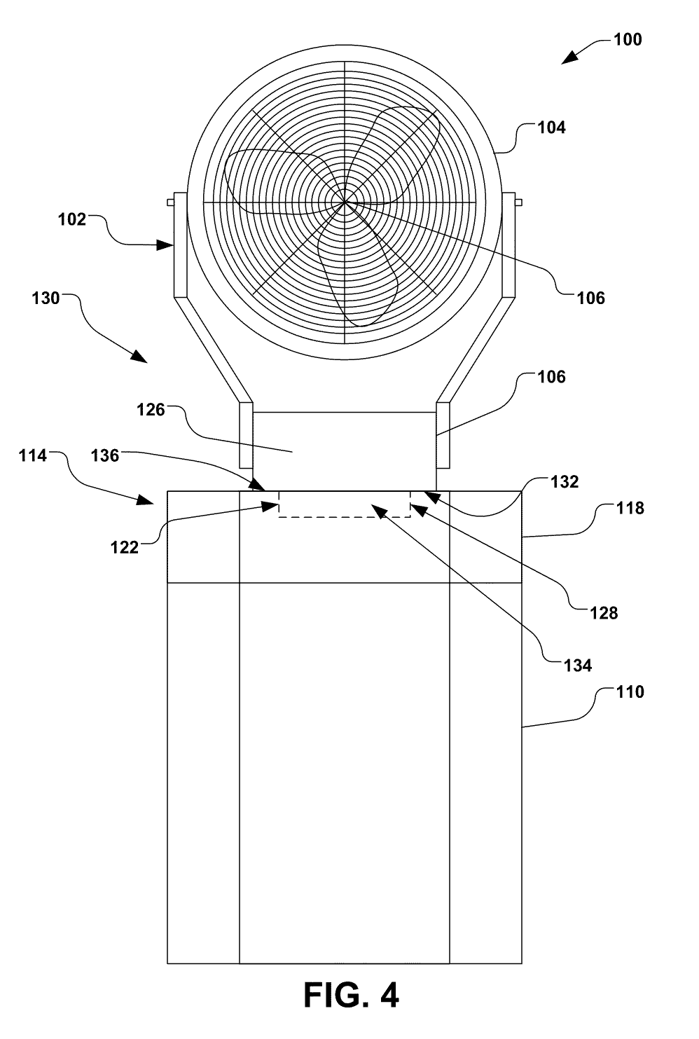

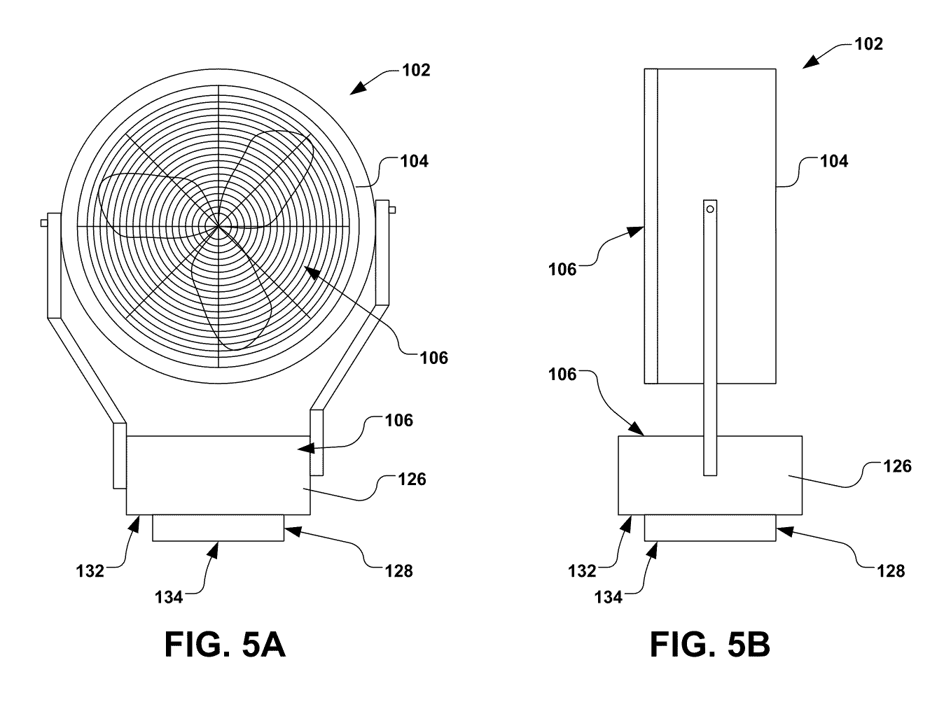

In accordance with another aspect, as illustrated in FIGS. 4 and 5A-5B, for example, the misting apparatus 102 further comprises a base 126 associated with the spraying apparatus 106, wherein the base is operably coupled to the fan 104. In the present example, the recess 122 in the lid 118 is appropriately sized and shaped to provide a compression fit around at least a portion 128 of the base 126, therein selectively securing the base to the lid in the first configuration 130. For example, the at least a portion 128 of the base 126 and the recess 122 are generally cylindrical. According to yet another example, the base 126 further comprises a shoulder 132, wherein a lower portion 134 of the base is configured to selectively engage the recess 122 of the lid 118, and wherein the shoulder is configured to stabilize the base about a top portion 136 of the lid in the first configuration 130 illustrated in FIG. 4.

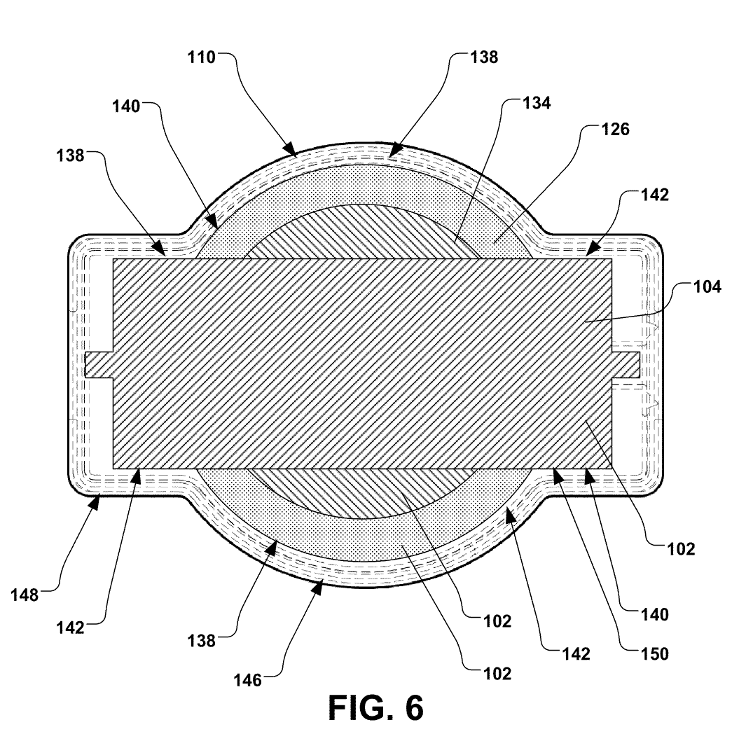

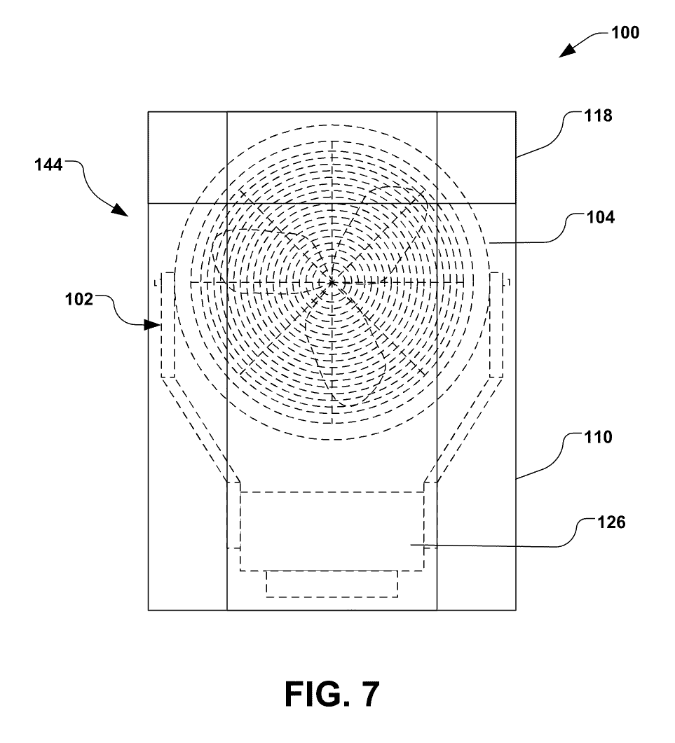

When viewed from the open end 114 of the water container 110, as illustrated in FIG. 6 in accordance with another example, the water container has a cross-sectional profile 138 that at least partially approximates a cross-sectional profile 140 of the misting apparatus 102 when the misting apparatus is further viewed from the top of the evaporative cooling system of FIG. 1. For example, as illustrated in FIG. 6, the misting apparatus 102 (e.g., comprising the fan 104, spraying apparatus 106 and base 126) is configured to selectively slidingly engage at least part 142 of the cross-sectional profile 138 of the water container 110, therein selectively securing the misting apparatus 102 inside a volume of the water container 110 in a second configuration 144 illustrated in FIG. 7.

In a preferred embodiment, the cross-sectional profile 140 of the water container 110, as illustrated in FIG. 6, comprises a substantially cylindrically shaped portion 146 interrupted by one or more transverse extensions 148 extending radially outward therefrom, The one or more transverse extensions 148 are thus configured to slidingly engage at least a portion 150 of the fan 104 of the misting apparatus 102 in the second configuration 144 illustrated in FIG. 7. Thus, the cross-section profile 140 of the water container 110 is considered to be a “key shaped” cross section, wherein the misting apparatus 102 is secured within the water container 110 in the second configuration 144 thereof, therein protecting the misting apparatus from damage during transportation and/or storage.

In accordance with another example, one or more engagement members (e.g., one or more protrusions, indentations, screws, pins, latches, etc.) are associated with one or more of the base 126 and the recess 122, wherein the one or more engagement members selectively affix the base to the lid 118 in the second configuration 144 of FIG. 7. In another example, one or more of the base 126 and recess 122 are generally frustoconical in shape, wherein a friction fit is achieved between the base and recess. According to yet another example, FIGS. 1 and 2 further illustrate an alcove 152 provided at the closed end 116 of the water container 110. The alcove 152, for example, is provided for placement of a spigot (not shown) for drainage of the water container 110. Alternatively, the alcove 152 provided a location for attachment and securement of the water container 110 to another object, such as a rack, frame, or other object (not shown).

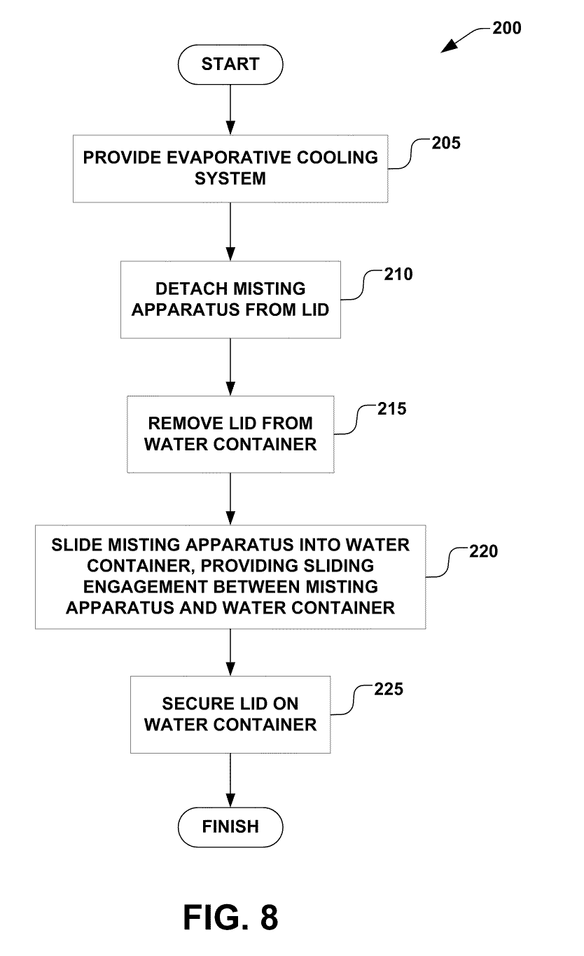

In accordance with another aspect of the present invention, FIG. 8 illustrates a exemplary method 200 for utilizing and stowing an evaporative cooling system. While exemplary methods are illustrated and described herein as a series of acts or events, it will be appreciated that the present invention is not limited by the illustrated ordering of such acts or events, as some steps may occur in different orders and/or concurrently with other steps apart from that shown and described herein, in accordance with the invention. In addition, not all illustrated steps may be required to implement a methodology in accordance with the present invention. Moreover, it will be appreciated that the methods may be implemented in association with the systems illustrated and described herein as well as in association with other systems not illustrated.

As illustrated in FIG. 8, the method 200 begins with providing an evaporative cooling system in act 205, wherein the evaporative cooling system comprises a water container and a misting apparatus operatively coupled to a lid enclosing an open end of the water container. In act 210, the misting apparatus is detached from the lid, and the lid is removed from the water container in act 215. At this point, the water container can be emptied and optionally dried of any remaining water disposed therein.

In act 220, the misting apparatus is slid into the water container, wherein opposing portions of the misting apparatus slidingly engage opposing portions of the water container. For example, opposing portions of a fan of the misting apparatus is slid along two diametrically-opposed transverse extensions of the water container. In act 225, the lid is secured to the open end of the water container, therein enclosing and securing the misting apparatus within the water container for easy transportation and/or storage of the evaporative cooling system.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A portable evaporative cooling system, comprising:
a misting apparatus comprising a fan and a spraying apparatus, wherein the fan is configured to generate a path of air, and wherein the spraying apparatus is configured to disperse water in the path of air generated by the fan for evaporation thereof;
a substantially hollow water container operable to store the water, wherein the water container has an elongate body having an open end and a closed end, wherein, when viewed from the open end, the water container has a cross-sectional profile that at least partially approximates a cross-sectional profile of the misting apparatus, wherein the misting apparatus is configured to selectively slidingly engage at least part of the cross-sectional profile of the water container, therein selectively securing the misting apparatus inside a volume of the water container; and
a lid in selective cooperative engagement with the open end of the water container, the lid having an access port therethrough, wherein in a first configuration, the misting apparatus is operatively coupled to an external portion of the lid, and wherein the misting apparatus is configured to draw water from the water container through the access port, and wherein in a second configuration, the lid encloses the misting apparatus within an interior region of the water container.

2. The portable evaporative cooling system of claim 1, wherein the misting apparatus further comprises a base operably coupled to the fan, and wherein the external of the lid comprises a recess defined therein, wherein the recess is sized and shaped to provide a compression fit around at least a portion of the base, therein selectively securing the base to the lid in the first configuration.

3. The portable evaporative cooling system of claim 2, wherein the base and recess are generally cylindrical.

4. The portable evaporative cooling system of claim 2, further comprising one or more engagement members associated with one or more of the base and the recess, wherein the one or more engagement members selectively affix the base to the lid in the second configuration.

5. The portable evaporative cooling system of claim 2, wherein one or more of the base and recess are generally frustoconical in shape.

6. The portable evaporative cooling system of claim 2, wherein the access port is defined within the recess of the lid.

7. The portable evaporative cooling system of claim 2, wherein the base further comprises a shoulder, wherein a lower portion of the base is configured to selectively engage the recess of the lid, and wherein the shoulder is configured to stabilize the base about a top portion of the lid in the first configuration.

8. The portable evaporative cooling system of claim 1, further comprising a port sealing member, wherein the port sealing member is configured to selectably engage the access port when the lid in the second configuration.

9. The portable evaporative cooling system of claim 1, wherein the cross-sectional profile of the water container comprises a substantially cylindrically shaped portion interrupted by one or more transverse extensions extending radially outward therefrom, wherein the one or more transverse extensions are configured to slidingly engage at least a portion of the fan of the misting apparatus in the second configuration.

10. The portable evaporative cooling system of claim 7, wherein the cross-sectional profile of the water container comprises two transverse extensions diametrically-opposed from one another, wherein the two transverse extensions are configured to slidingly engage diametrically opposed portions of the fan in the second configuration.

11. The portable evaporative cooling system of claim 1, wherein one or more of the water container and lid further comprise insulative material configured to thermally insulate the water in the water container.

12. The portable evaporative cooling system of claim 1, wherein the misting apparatus further comprises a water pump in fluid communication with the water container for drawing water therefrom.

13. The portable evaporative cooling system of claim 1, wherein the misting apparatus further comprises one or more misting nozzles disposed downstream of the fan and in the path of air generated therefrom.

14. The portable evaporative cooling system of claim 1, wherein one or more of the water container and lid comprise one or more handles defined therein, wherein the one or more handles provide a location for carrying the portable evaporative cooling system.

15. The portable evaporative cooling system of claim 14, wherein the one or more handles provide a fluid communication between the interior region of the water container and an external environment.

16. A portable evaporative cooling system, comprising:
a cooling means for providing evaporative cooling;
a water container means having an opening and a storage means for selectively securing the cooling means; and
a cover means for covering the opening of the water container means, wherein in a first configuration, the cover means is configured to support the cooling means external to the water container means, and wherein in a second configuration, the cover means is configured to enclose the cooling means within the water container means.

17. The portable evaporative cooling system of claim 16, wherein the storage means comprises a generally key-shaped cross-section water container means.

18. The portable evaporative cooling system of claim 17, wherein the cooling means comprises a fan, wherein storage means selectively slidingly engages at least a portion of the fan.

19. A method for storing of an evaporative cooling system, the method comprising:
providing an evaporative cooling system comprising a water container and a misting apparatus operatively coupled to a lid enclosing an open end of the water container;
detaching the misting apparatus from the lid;
removing the lid from the water container;
sliding the misting apparatus into the water container, wherein opposing portions of the misting apparatus slidingly engage opposing portions of the water container; and
securing the lid to the open end of the water container, therein enclosing and securing the misting apparatus within the water container.

20. The method of claim 19, wherein sliding the misting apparatus into the water container comprises sliding opposing portions of a fan of the misting apparatus along two diametrically-opposed transverse extensions of the water container.
